(19) United States
(12) Patent Application Publication
(10) Pub. No.: US 2011/0184709 A1
(43) Pub. Date: Jul. 28, 2011

(54) Interactive Simulations on a Handheld Calculator

(76) Inventors: Daniel R. Gremillion, Fairview, TX (US); Randall John Satchell, Frisco, TX (US)

(21) Appl. No.: 12/695,153

(22) Filed: Jan. 27, 2010

(51) Int. Cl. G06G 7/48

(52) U.S. Cl. 703/3

(57) ABSTRACT

Methods for interactive simulation using a handheld calculator are provided. One method for interactive simulation includes receiving, by the handheld calculator, experiment data from a data source collecting the experiment data as an experiment is conducted, and using a portion of the experiment data to drive behavior of a simulation of the experiment executing on the handheld calculator. Another method for interactive simulation includes executing a simulation of an experiment on the handheld calculator, and sending, by the handheld calculator, experiment control data generated by the simulation to a data source operatively connected to the experiment, wherein the data source uses the experiment control data to control the experiment.

### BACKGROUND OF THE INVENTION

A student can currently use a handheld graphing calculator and a low-cost sensor, i.e., a computerized measuring device, connected to the calculator to automatically collect data from a laboratory experiment and to perform various analyses of the collected data using software tools on the calculator. However, further improvements in the software tools available for performing laboratory experiments using handheld graphing calculators and sensors are desirable to enhance the student learning experience.

### BRIEF DESCRIPTION OF THE DRAWINGS

Particular embodiments in accordance with the invention will now be described, by way of example, and with reference to the accompanying drawings:

FIGS. 1A-1C show interactive simulation systems in accordance with one or more embodiments of the invention;

FIG. 2 shows an example of a calculator in accordance with one or more embodiments of the invention;

FIG. 3 is a block diagram of a calculator in accordance with one or more embodiments of the invention;

FIG. 4 is a block diagram of an interactive simulation system in accordance with one or more embodiments of the invention; and

FIGS. 5 and 6 are flow diagrams of methods for interactive simulation in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components of computer and handheld calculator systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless connection. Thus, if a first device couples to a second device, that connection may be through a direct connection, through an indirect connection via other devices and connections, through an optical connection, and/or through a wireless connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps and/or number of steps shown in the figures and/or described herein.

Embodiments of the present invention are discussed below with respect to an embodiment in which a calculator is used as an input device. It should be noted, however, that embodiments of the present invention may be useful for other types of electronic devices, particularly handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

Embodiments of the present invention provide for interactive simulations on handheld calculators in an instructional setting such as a classroom or laboratory. In embodiments of the invention, an interactive simulation is a simulation of an experiment executing on a handheld calculator that can receive and react to experiment data from a data source coupled to a real world experiment and/or send experiment control information generated by the simulated experiment to a data source coupled to a real world experiment to control the real world experiment. More specifically, in one or more embodiments of the invention, a handheld calculator is coupled to a data source configured to communicate with a real world experiment as the experiment is conducted. The calculator is configured to execute a simulation of the experiment. In some embodiments of the invention, the data source collects experiment data as the experiment is conducted and sends the experiment data to the calculator. At least some of the received experiment data is used to drive the simulation of the experiment concurrently executing on the calculator. In some embodiments of the invention, the data source controls some or all of the actions for conducting the experiment. In some embodiments of the invention, as the simulation of the experiment is executed on the calculator, the simulation generates experiment control information that is sent to the data source. The data source then uses the received experiment control information to control at least some of the actions needed to conduct the experiment.

The capability to perform interactive simulations using a handheld calculator improves the ability to learn concepts by providing functionality beyond that of mere data collection and analysis or mere simulation alone. For example, consider an experiment in which a student (or other user) is to drop a ball and derive the acceleration of gravity. The student can attach a sensor such as a sonic ranger measurement tool to a handheld graphing calculator. The student can then drop a ball and the measurement tool would measure the rate of the descent of the ball falling or bouncing. More specifically, it would measure the rate and velocity of the ball and provide that experiment data to the calculator. The student can use the experiment data and analysis tools on the calculator to analyze the data and determine the acceleration of gravity. With a simulation capability, a student can simulate the same experiment on a computer (e.g., a desktop computer or a laptop) without the need for measurement tools and a ball, observing a simulation of dropping the ball on a display and analyzing the resulting data from the simulation. However, using a simulation may have less learning impact than actual involvement in a real world experiment.

With embodiments of the interactive simulation capability described herein on a handheld calculator, a student has the ability to collect experiment data from a real world experiment using a data source coupled to the calculator, to simulate the experiment on the calculator, and to have interaction, i.e., sharing of data, between the simulation and the real world experiment. For example, the student can instrument a real world experiment using a sensor coupled to the calculator, start a simulation of the experiment on the calculator, and conduct the real world experiment during which experiment data is collected from the real world experiment and concurrently used to drive the behavior of the simulation on the calculator. Seeing the simulation driven by the real world experiment data may give the student a deeper understanding of how things are changing as the experiment progresses. In addition, the student may continue use of the simulation with the collected experiment data to expand on the experiment in ways that would not be possible in the real world experiment. For example, continuing the previous example of an experiment involving dropping a ball to determine the acceleration of gravity, the student could use the simulation of the experiment to change the gravitational force (e.g., use the gravitational force of another planet), change the mass of the ball, etc., while continuing to use other parameter values from the collected experiment data.

In another example of interaction between a simulation and a real world experiment, the student can instrument a real world experiment using a sensor coupled to the calculator, start a simulation of the experiment on the calculator, and use data from the simulation to control the real world experiment. This capability may be used, for example, to replicate a real world experiment and/or to make changes to a real world experiment to affect the outcome in some way. For example, consider a biology experiment in which pH measurements are made in a real world experiment in which the changes in the pH of water at various intervals over a period of time are recorded. The student can replicate the experiment by configuring a simulation on the calculator to simulate the actual experiment and send experiment control information to a data source coupled to the real world experiment at the various intervals to cause the pH of the water in the real world experiment to change to the associated pH level. As is explained in more detail below, a data source may include multiple sensors. For this example, the data source may include, for example, a pH sensor and a digital control device that can be activated responsive to experiment control data to cause a mechanism to add chemical substances to the water to change the pH.

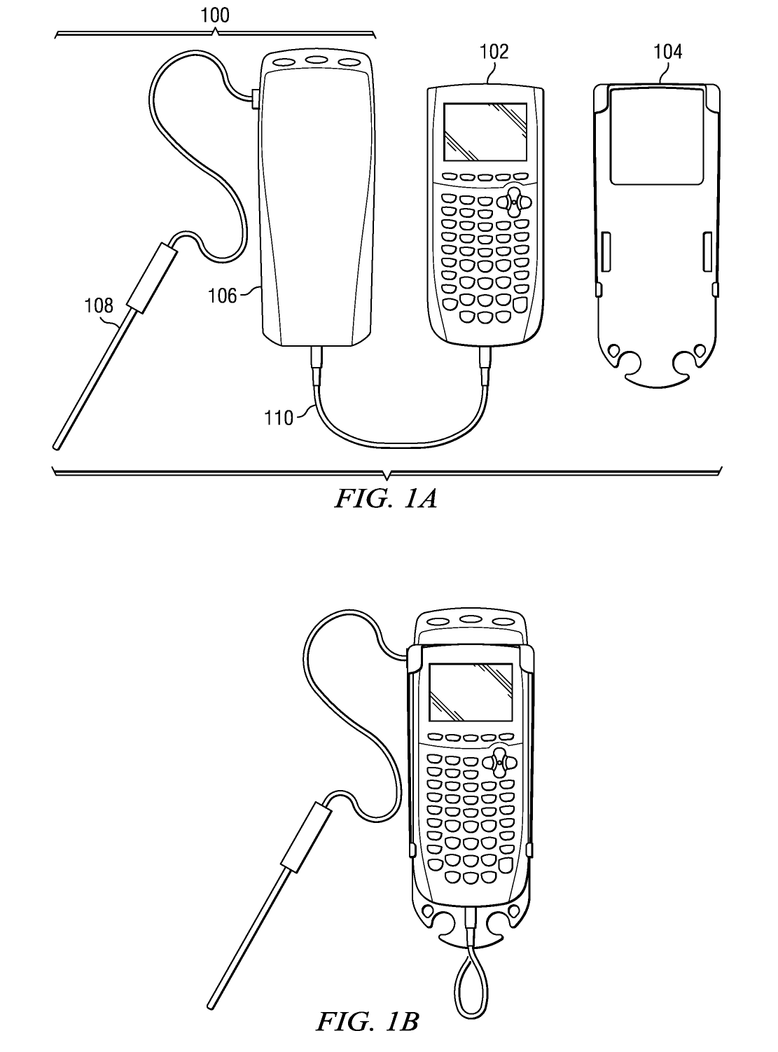

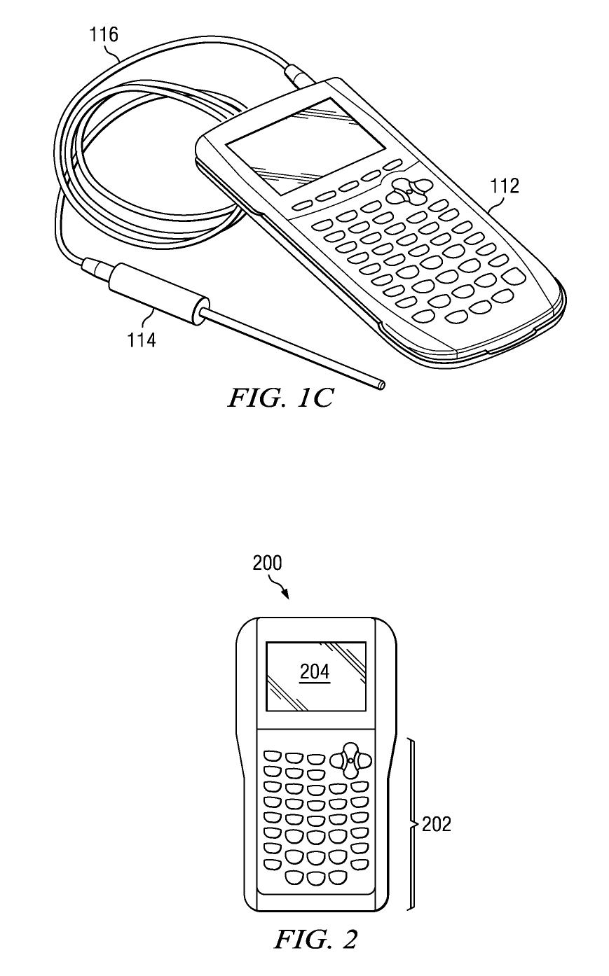

FIGS. 1A-1C show interactive simulation systems in accordance with one or more embodiments of the invention. As shown in FIGS. 1A and 1C, an interactive simulation system includes a data source (100, 114), and a handheld calculator (102, 112) coupled to the data source (100, 114) by a communication link (110, 116). The handheld calculator (102, 112) may be any suitable handheld calculator, such as, for example, the TI-84 Plus graphing calculator or the TI-Nspire graphing calculator manufactured by Texas Instruments, Inc., of Dallas, Tex. In some embodiments of the invention, the handheld calculator (102, 112) is configured to execute a simulation of a real world experiment, to receive experiment data collected from the real world experiment from the data source (100, 114), and to use at least some of the experiment data to affect the behavior of the simulation. In some embodiments of the invention, the handheld calculator (102, 112) is configured to execute a simulation of a real world experiment and to send experiment control information generated by the simulation to the data source (100, 114) to be used to control the behavior of the real world experiment. The handheld calculator (102, 112) is described in more detail herein in reference to FIGS. 2-4.

The communication link (110, 116) between the handheld calculator (102, 112) and the data source (100, 114) is shown as a wired interface for illustrative purposes. In some embodiments of the invention, the wired interface is a USB communications link. In some embodiments of the invention, the communication link (110, 116) may be a wireless interface and/or a combination of wired and wireless interfaces. The communication link (110, 116) may be configured to provide uni-directional communication from the handheld calculator (102, 112) to the data source (100, 114), uni-directional communication from the data source (100, 114) to the handheld calculator (102, 112), or bi-directional communication between the data source (100, 114) and the handheld calculator (102, 112).

In one or more embodiments of the invention, the data source (100, 114) is configured to provide experiment data from a real world experiment to the handheld calculator (102, 112) and/or to receive experiment control information from the handheld calculator (102, 112). In one or more embodiments, the data source (100, 114) includes a sensor (108, 114) and circuitry to receive experiment data from the sensor and provide the experiment data to the handheld calculator (102, 112). In some embodiments of the invention, the data source (100, 114) includes circuitry to receive experiment control data from the handheld calculator (102, 112) and use the experiment control data to operate the sensor (108, 114) to control the behavior of a real world experiment.

The sensor (108, 114) is depicted as a simple probe type sensor for illustrative purposes. In embodiments of the invention, the sensor may be any sensor suitable for use in the data source (100, 114), including, but not limited to, a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, a pH sensor, an accelerometer, a barometer, a blood pressure sensor, a charge sensor, a radiation sensor, a heart rate monitor, a spirometer, a photogate, a UVA sensor, a UVB sensor, a digital control device, and a thermocouple. Further, in some embodiments of the invention, more than one sensor may be included in the data source (100, 114).

In one or more embodiments of the invention, as shown in FIG. 1A, the data source (100) may include a data collection system (106) coupled between the handheld calculator (102) and the sensor (108). The data collection system (106) is a computing system configured to support data collection from one or more sensors, providing storage capacity for storing collected experiment data and functionality to transfer the collected experiment data to the handheld calculator (102). In some embodiments of the invention, the data collection system (106) is configured to receive experiment control data from the handheld calculator (102) and appropriately apply the experiment control data to one or more sensors. In some embodiments of the invention, the data collection system (106) is a portable, handheld, battery-operated computing device. As shown in FIG. 1A, an interactive simulation system in which the data source (100) includes a data collection system (106) may include a mounting cradle (104). The mounting cradle (104) is used to mount the handheld calculator (102) on the data collection system (106) as depicted in FIG. 1B.

FIG. 2 shows an example of a handheld calculator (200) (e.g., 102, 112 of FIGS. 1A and 1C) in accordance with one or more embodiments of the invention. For illustrative purposes, the handheld calculator illustrated in FIG. 2 is similar to graphing calculators available from Texas Instruments. As shown in FIG. 2, the handheld calculator (200) includes a graphical display (204) and a set of keys (202). The graphical display (204) may be used to display, among other things, various outputs of an interactive simulation executing on the handheld calculator (200). The graphical display (204) may be, for example, an LCD display. The set of keys (202) allows a user, e.g., a student, to enter data and functions and to start and interact with an interactive simulation executing on the handheld calculator (200).

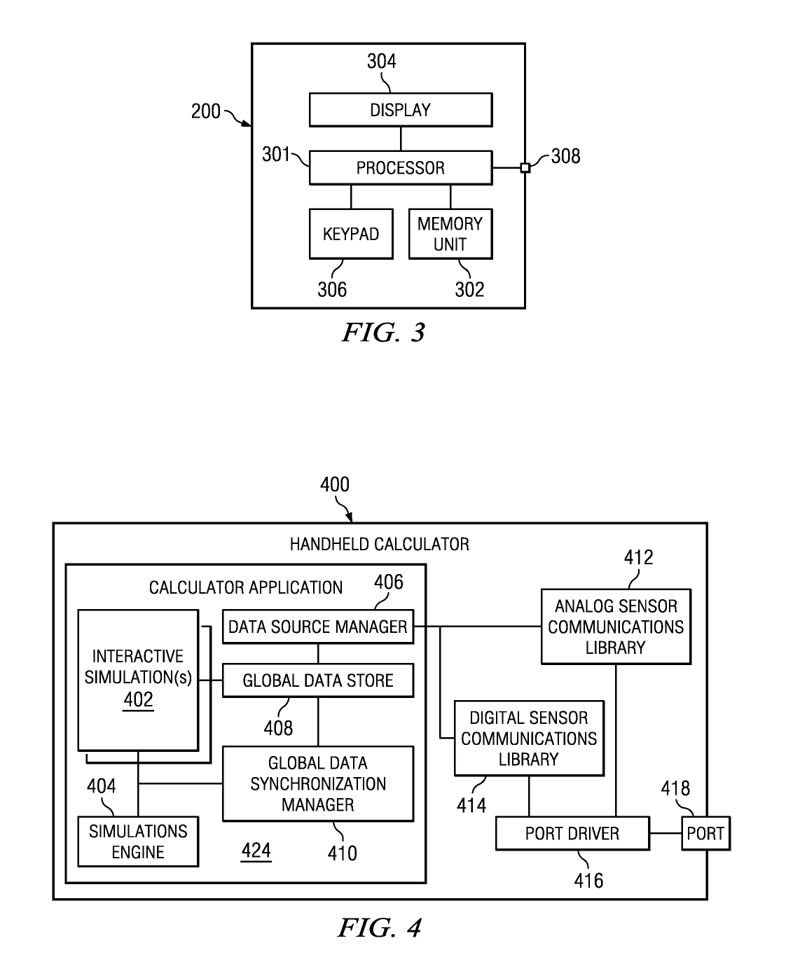

FIG. 3 is a block diagram of the handheld calculator (200) in accordance with one or more embodiments of the invention. Generally, the handheld calculator (200) includes a processor (301) coupled to a memory unit (302), which may include one or both of read-only memory (ROM) and random-access memory (RAM). In some embodiments of the invention, the ROM stores software programs and the RAM stores intermediate data and operating results. An input/output port (308) provides connectivity to data sources (as shown in FIGS. 1A-1C). In one or more embodiments of the invention, the input/output port (308) is a bi-directional connection such as a mini-A USB port. Also included in the handheld calculator (200) are a display (304) and a keypad (306).

FIG. 4 is a block diagram of a handheld calculator (400) (e.g., 102, 112 of FIGS. 1A and 1C) configured to perform interactive simulations. The handheld calculator (400) includes a calculator application (424) with functionality to execute interactive simulations, an analog sensor communications library (412), a digital sensor communications library (414), a port driver (416), and a port (418). The analog sensor communications library (412) and the digital sensor communications library (414) include functionality for handling communication between the calculator application (424) and analog and digital data sources connected to the handheld calculator (400) via the port (418). More specifically, the communications libraries (412, 414) include functionality to process experiment control data generated by the interactive simulations (402), receive and format experiment data from data sources coupled to the handheld calculator (424), and provide the formatted experiment data to the data source manager (406). The port (418) (e.g., a USB port) provides wired connectivity to analog and digital data sources. The port driver (416) (e.g., a USB port driver) includes functionality for handling device level communication between the communications libraries (412, 414) and the port (418).

The calculator application (424) includes a simulations engine (404), one or more interactive simulations (402), a data source manager (406), a global data store (408), and a global data synchronization manager (410). The data source manager (406) includes functionality to abstract data sources used by the interactive simulations (402) and to manage getting experiment data into the global data store (408) from data sources and sending experiment control data from the global data store (408) to data sources. More specifically, the data source manager (406) includes functionality to receive experiment data from the communications libraries (412, 414) and store the experiment data in the global data store (408). The data source manager (406) also includes functionality to retrieve experiment control data generated by executing interactive simulations (402) from the global data store (408) and send the experiment control data to the communications libraries (412, 414).

The global data store (408) stores formatted experiment data from the data source manager (406), experiment control data from executing interactive simulations (402), and other data shared by executing interactive simulations (402). The global data synchronization manager (410) includes functionality to allow multiple executing interactive simulations (402) as well as other concurrently executing calculator applications to use and manipulate the same data while keeping the user interfaces of the simulations and other applications that are displaying information tied to the data up-to-date and synchronized. For example, the global data synchronization manager (410) includes functionality to publish a change to a shared variable made by one calculator application so that any other interested applications can update their user interfaces as needed based on the change. Other calculator applications may be, for example, a traditional calculator application, a graphing application that provides functionality to graph functions, plot sets of data points, etc., and a plotting application that provides functionality for plotting and graphing sets of data.

The simulations engine includes functionality to execute one or more interactive simulations (402). An interactive simulation (402) includes functionality to simulate an experiment when executed by the simulations engine (404). Further, when executed, an interactive simulation (402) may use and manipulate data from the global data store (408). In some embodiments of the inventions, an interactive simulation (402) includes functionality to simulate a real world experiment that is concurrently conducted, to receive experiment data from a data source collecting the experiment data from the real world experiment, and to modify the behavior of the simulated experiment based on the received experiment data. In some embodiments of the inventions, an interactive simulation (402) includes functionality to simulate a real world experiment that is concurrently conducted and to generate experiment control data to be sent to a data source configured to provide control information to the real world experiment to modify the behavior of the real world experiment.

Operation of an embodiment of the interactive simulation system of FIG. 4 is now explained by way of an example. The example is provided for illustrative purposes and should not be considered as limiting the invention as claimed. An interactive simulation (402) may be implemented to model the chemical reactions of different substances in liquid as heat is either added or removed from the solution. In the simulation, the solutes and solvent can be selected by the user, and the rate of increase or decrease of heat can be chosen. The user may then choose to view the chemical reactions at a gross level (physical changes such as color or volume), or at a molecular level (changes in state or activity, how the elements combine or dissociate from one another, etc.). The interactive simulation (402) may be driven by a real-world experiment which duplicates the parameters of the simulation in a laboratory with actual equipment, solvents, and solutes.

Once both the experiment and simulation (402) are configured, a data source that includes a temperature probe and a digital control device is connected to the handheld calculator (400) via the port (418) and the temperature sensor inserted into the real solution. The temperature sensor measures the actual temperature of the real solution and temperature points, i.e., experiment data, are provided to the data source manager (406) via the port (418), the port driver (416), and the analog sensor communications library (412). The data source manager (406) stores the experiment data in the global data store (408) for use by the interactive simulation (402). The interactive simulation (402) then uses the experiment data to drive the rate of change in heat in the simulation. In this way, the user can experience the physical changes of the real world experiment which cannot be simulated (e.g., odor), while simultaneously observing changes (e.g., molecular changes) via the simulation which cannot be seen in a typical student laboratory environment.

Once the experiment reaches a point past which further increase in heat is either not possible with the laboratory equipment or is unsafe in the learning environment, the interactive simulation (402) prompts the student that the real-world experiment is to be terminated. The interactive simulation (402) sends experiment control data via the digital sensor communications library (412), the port driver (416), and the port (418) to the digital control device which activates a mechanism to turn off the heating apparatus of the real-world experiment. The interactive simulation (402) continues to progress by increasing the heat variable within the simulation, ignoring all further input from the temperature sensor, thereby allowing the student to further explore the experiment in a purely simulated and safe manner.

As the real world experiment is conducted and the interactive simulation (402) is being executed, one or more other calculator applications concurrently executing on the handheld calculator (400) may also use the experiment data in the global data store (408). For example, a plotting application may be configured to dynamically plot the temperature points so that any chemical changes which result in a spike or drop in temperature are more readily apparent. The global synchronization manager (410) ensures that both the interactive simulation (402) and the plotting application receive these temperature points from the global data store (408).

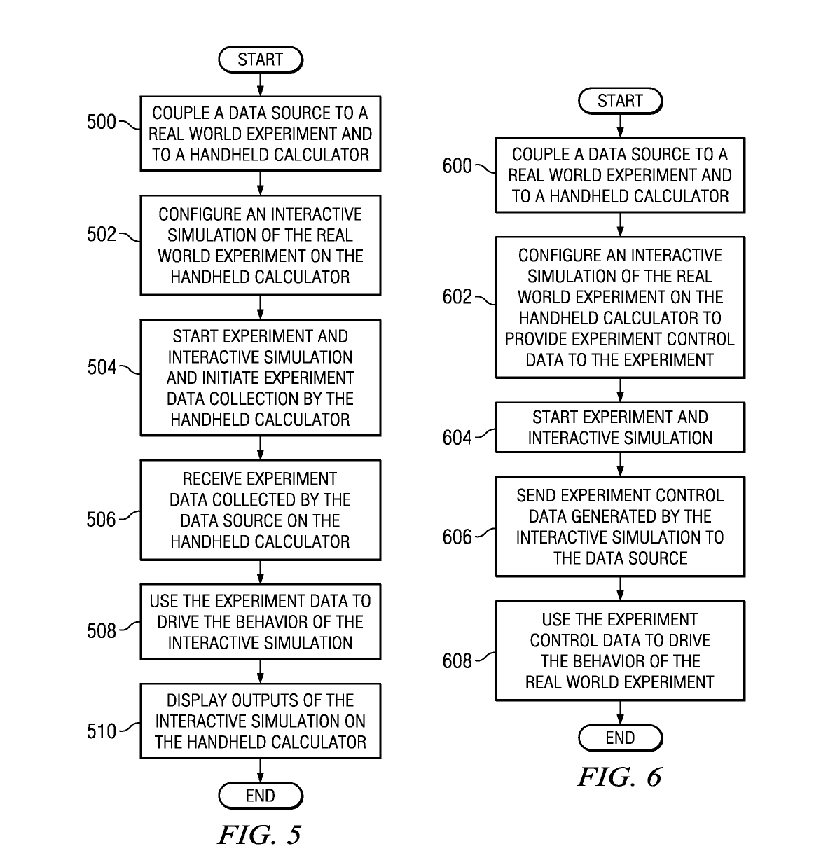

FIG. 5 is a flow diagram of a method for interactive simulation in accordance with one or more embodiments of the invention. Initially, a data source is coupled to a real world experiment and to a handheld calculator (500). An interactive simulation of the real world experiment is also configured for execution on the handheld calculator (502). The conduct of the experiment is then started, the interactive simulation is concurrently executed on the handheld calculator, and experiment data collection from the data source is initiated on the handheld calculator (504). The experiment data collected by the data source is received by the handheld calculator (506) and at least part of the experiment data is used to drive the behavior of the interactive simulation (508). As the interactive simulation is executing, outputs from the simulation are displayed on a display of the handheld calculator (510).

FIG. 6 is a flow diagram of a method for interactive simulation in accordance with one or more embodiments of the invention. Initially, a data source is coupled to a real world experiment and to a handheld calculator (600). An interactive simulation of the real world experiment is also configured for execution on the handheld calculator and to provide experiment control data to the experiment (602). The conduct of the experiment is then started and the interactive simulation is concurrently executed on the handheld calculator (604). The experiment control data generated by the interactive simulation is sent to the data source (606) and at least part of the experiment control data is used to drive the behavior of the real world experiment (608).

Embodiments of the invention may include software instructions executable by a processor of a handheld calculator to perform interactive simulations as described herein. The software instructions may be initially stored in a computer-readable medium such as a compact disc (CD), a diskette, a tape, a file, memory, or any other computer readable storage device and loaded and executed by the processor. In some cases, the software instructions may also be sold in a calculator program product, which includes the computer-readable medium and packaging materials for the computer-readable medium. In some cases, the software instructions may be distributed to a handheld calculator via removable computer readable media (e.g., floppy disk, optical disk, flash memory, USB key), via a transmission path from computer readable media on a computer system, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method for interactive simulation using a handheld calculator, the method comprising:
receiving, by the handheld calculator, experiment data from a first data source collecting the experiment data as a first experiment is conducted; and
using a portion of the experiment data to drive behavior of a first simulation of the first experiment executing on the handheld calculator.

2. The method of claim 1, further comprising displaying outputs of the first simulation on the handheld calculator.

3. The method of claim 1, further comprising formatting the experiment data prior to use by the first simulation.

4. The method of claim 1, further comprising storing the experiment data in a global data store.

5. The method of claim 3, further comprising using the stored experiment data by an application executing on the handheld calculator.

6. The method of claim 1, further comprising,
executing a second simulation of a second experiment on the handheld calculator; and
sending, by the handheld calculator, experiment control data generated by the second simulation to a second data source operatively connected to the second experiment, wherein the second data source uses the experiment control data to control the second experiment.

7. The method of claim 6, wherein the first simulation and the second simulation are a same simulation and the first experiment and the second experiment are a same experiment.

8. The method of claim 1, wherein the data source comprises at least one selected from a group consisting of a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, a pH sensor, an accelerometer, a barometer, a blood pressure sensor, a charge sensor, a radiation sensor, a heart rate monitor, a spirometer, a photogate, a UVA sensor, a UVB sensor, a digital control device, and a thermocouple.

9. A method for interactive simulation using a handheld calculator, the method comprising:
executing a first simulation of a first experiment on the handheld calculator; and
sending, by the handheld calculator, experiment control data generated by the first simulation to a first data source operatively connected to the first experiment, wherein the first data source uses the experiment control data to control the first experiment.

10. The method of claim 9, further comprising,
receiving, by the handheld calculator, experiment data from a second data source collecting the experiment data as a second experiment is conducted; and
using a portion of the experiment data to drive behavior of a second simulation of the second experiment executing on the handheld calculator.

11. The method of claim 10, wherein the first simulation and the second simulation are a same simulation and the first experiment and the second experiment are a same experiment.

12. The method of claim 9, wherein the data source comprises at least one selected from a group consisting of a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, a pH sensor, an accelerometer, a barometer, a blood pressure sensor, a charge sensor, a radiation sensor, a heart rate monitor, a spirometer, a photogate, a UVA sensor, a UVB sensor, a digital control device, and a thermocouple.

13. An interactive simulation system comprising:
a handheld calculator; and
a data source operatively connected to an experiment and to the handheld calculator,
wherein the handheld calculator is configured to
receive experiment data from the data source as the experiment is conducted; and
use a portion of the experiment data to drive a simulation of the experiment executing on the handheld calculator.

14. The interactive simulation system of claim 13, wherein the handheld calculator is configured to
send experiment control data generated by the simulation to the data source, wherein the data source uses the experiment control data to control the experiment.

15. A handheld calculator comprising:
a processor;
a memory coupled to the processor;
a simulations engine stored in the memory and executable by the processor; and
a first simulation of a first experiment stored in the memory and executable by the simulations engine,
wherein, when executed, the first simulation receives experiment data from a first data source collecting the experiment data as the first experiment is conducted, and uses a portion of the experiment data to drive behavior of the first simulation.

16. The handheld calculator of claim 15, further comprising a second simulation of a second experiment stored in the memory and executable by the simulations engine, wherein, when executed, the second simulation generates experiment control data, wherein the experiment control data is sent to a second data source operatively connected to the second experiment, wherein the experiment control data is used to control the second experiment.

17. The handheld calculator of claim 15, further comprising a data source manager configured to receive the experiment data from the first data source and store the experiment data in the memory for use by the first simulation.

18. The handheld calculator of claim 16, wherein the first simulation and the second simulation are a same simulation and the first experiment and the second experiment are a same experiment.
